(19) United States
(12) Patent Application Publication
(10) Pub. No.: US 2023/0350088 A1
(43) Pub. Date: Nov. 2, 2023

(54) MODEL PARAMETER DESIGN METHOD AND DEVICE FOR SIMULATING PROPAGATION OF SEISMIC WAVES AT ANY DISCONTINUOUS INTERFACE

(71) Applicant: Institute of Geology and Geophysics, Chinese Academy of Sciences, Beijing (CN)

(72) Inventors: Jian CAO, Beijing (CN); Shoudong HUO, Beijing (CN); Xuhui ZHOU, Beijing (CN)

(73) Assignee: Institute of Geology and Geophysics, Chinese Academy of Sciences, Beijing (CN)

(21) Appl. No.: 17/833,911

(22) Filed: Jun. 7, 2022

(30) Foreign Application Priority Data
Apr. 29, 2022 (CN) 2022104780365

(51) Int. Cl. G01V 1/28

(52) U.S. Cl. CPC G01V 1/282; G01V 2210/673

(57) ABSTRACT

The present invention discloses a model parameter design method and device for simulating propagation of seismic waves at any discontinuous interface, including: reading source wavelet and model parameters; selecting a space step and a time step according to the model parameters, and setting a space order of the finite difference numerical simulation; discretizing the discontinuous interface in the medium, and according to the threshold judgment criteria, obtaining many staircase discretization results for the discontinuous interface; conducting a forward modeling on the obtained multiple results of staircase discretization for the discontinuous interface by using the finite difference method, and setting parameters of the forward modeling; and obtaining the final simulation results by the superposition of the forward modeling results of different staircase-discretization of the discontinuous interface. The present invention can greatly improve the calculation efficiency.

### CROSS-REFERENCE TO RELATED APPLICATIONS

The application claims priority to Chinese patent application No. 2022104780365, filed on Apr. 29, 2022, the entire contents of which are incorporated herein by reference.

### TECHNICAL FIELD

The present invention belongs to the technical field of high performance numerical simulation of medium seismic waves, and specifically, a model parameter design method and device for simulating propagation of seismic waves at any discontinuous interface.

### BACKGROUND

The finite difference method is a mainstream method used to simulate and study the seismic wave propagation in oil and gas exploration and development industry with its advantages of high computational accuracy, high operation speed, low memory consumption and easy programming. In essence, the finite difference method is an algorithm based on the strong solution form of the partial differential equation, and it is mainly applicable to the medium with uniform or smooth-varying parameters. However, in the case of the strong discontinuous interface with medium parameters, it often leads to problems such as computational instability, false numerals and reduced computational accuracy. In this case, the usual processing method applies grid refinement and parameter smoothing for the strong discontinuous interface of the medium thus to ease the parameter comparison between both sides of the interface, so as to ensure the stability and accuracy of the numerical simulation algorithm on the whole (except for the vicinity of the interface). However, the grid refinement at the discontinuous interface in this operation will lead to the increase of computation work and more time and memory space consumed for computation. Furthermore, the smoothing processing of medium parameters on the both sides of the strong discontinuous interface will reduce the accuracy of numerical simulation of wave propagation at the interface, while such strong discontinuous interfaces are generally of great significance in the seismology and oil and gas exploration and development.

### SUMMARY

The purpose of the present invention is to provide a model parameter design method and device for simulating propagation of seismic waves at any discontinuous interface to address the issues as mentioned in the background above.

To realize the above-mentioned purposes, the present invention provides the following technical solutions.

A model parameter design method for simulating propagation of seismic waves at any discontinuous interface includes following steps:
S101, reading source wavelet and model parameters;
S102, selecting a space step and a time step according to the model parameters, and setting a space order of the finite difference numerical simulation;
S103, discretizing the discontinuous interface in the medium, and according to the threshold judgment criteria, obtaining many staircase discretization results for the discontinuous interface;
S104, conducting a forward modeling on the multiple results of staircase discretization for the discontinuous interface by using the finite difference method, and setting parameters of the forward modeling; and
S105, obtaining the final simulation results by the superposition of the forward modeling results of different staircase-discretization of the discontinuous interface.

Further, the model parameters include source wavelet frequency, transverse wave velocity, longitudinal wave velocity, medium density and anisotropy parameters.

Further, the principle of superposition method is applied to discretize the discontinuous interface in the medium.

Further, the threshold judgment criteria is obtained by the following formula:

$${κ}_{n} ( x , z ) = \{ \begin{matrix}1 & α ( x , z ) > \frac{n}{N + 1} \\ 0 & α ( x , z ) \leq \frac{n}{N + 1}\end{matrix} ,$$

and the modeling results are obtained by the following formula:

$$v ( x , z , t ) = \frac{1}{N} {\sum }_{n = 1}^{N} v ( x , z , t , n ) ,$$

wherein Kₙ(x,z) represents the medium type of a grid node; Kₙ(x,z)=1 means that the medium at that grid node is a medium below the discontinuous interface; Kₙ(x,z)=0 means that the medium at that grid node is a medium above the discontinuous interface; α(x,z) represents a weighting coefficient; x and z mean grid coordinates; t represents time; v represents a particle velocity; n represents results of N^{th} staircase discretization; and N represents the number of times of staircase discretization.

Further, for each case of discretization of the discontinuous interface, the medium parameter modification method is used to modify the constitutive relation and density at the discontinuous interface respectively to conduct the numerical simulation for each case and to judge whether a maximum number of time steps is reached.

Further, if the maximum number of time steps is reached, the results of all the discretization cases are superimposed to obtain the final results of the numerical simulation; and if the maximum number of time steps is not reached, the particle velocity and particle stress are updated, and then geophone data is extracted and written into a file to rejudge whether the maximum number of time steps is reached.

To realize the above-mentioned purposes, the present invention also provides the following technical solutions.

A model parameter design device for simulating propagation of seismic waves at any discontinuous interface, comprising:
an acquisition module used to read source wavelet and model parameters;
a setting module used to select a space step and a time step according to the model parameters and to set a space order of the finite difference numerical simulation;
a discretization module used to discretize an discontinuous interface in the medium and obtain multiple results of staircase discretization for the discontinuous interface according to the threshold judgment criteria;
a simulation module used to conduct a forward modeling on the obtained multiple results of staircase discretization for the discontinuous interface by using the finite difference method and to set parameters of the forward modeling;
a superposition module used to superimpose the results of all the forward modeling to obtain final results of the forward modeling.

To realize the above-mentioned purposes, the present invention provides the following technical solutions.

A computer device comprising a memory and a processor, wherein the memory stores computer programs executed by a processor to implement the procedures of the method according to any of the above.

To realize the above-mentioned purposes, the present invention further provides the following technical solutions.

A computer readable storage medium has computer programs stored thereon, and the computer programs are executed by a processor to implement the procedures of the method according to any of the above.

Compared with the current technology, beneficial effects of the present invention mainly include the following.

It can be used as a discretization model generation and a preparation program, and can be directly integrated and applied to the existing velocity-stress staggered grid finite difference numerical programs in both the industry and the academia.

It can be accurately fitted with the spatial position of the discontinuous interface, and there is no rounding approximation used in the traditional staircase approximation method; moreover, there is no need for grid refinement and parameter smoothing at the strong discontinuous interface of the medium.

In the whole numerical simulation, only one medium model generation is required, with the advantages of efficient calculation and simple operation etc.

The medium models generated using this method are independent from each other, and their respective numerical simulations can be calculated in parallel (MPI or GPU); and finally, all wave fields are superimposed, greatly improving the computational efficiency.

The staircase approximation of the strong discontinuous interface of the medium can realize the numerical simulation of the irregular interface without any stability problem due to the maximum curvature constraint.

The high-order finite difference operator can be used to achieve the calculation precision equivalent to that of the precise realization method based on the weak solution class of the partial differential equations.

### BRIEF DESCRIPTION OF DRAWINGS

FIG. 1 shows a flowchart for a model parameter design method for simulating propagation of seismic waves at any discontinuous interface as provided in the present invention.

FIG. 2 shows a schematic view of any discontinuous interface realized using this staircase approximation and the medium average parameter method.

FIG. 3 shows a schematic diagram I of the superposition method.

FIG. 4 shows a schematic diagram II of the superposition method.

FIG. 5 shows a schematic diagram III of the superposition method.

FIG. 6 shows a schematic diagram IV of the superposition method.

FIG. 7 shows a flowchart of the algorithm.

FIG. 8 shows a block diagram of a model parameter design device for simulating propagation of seismic waves at any discontinuous interface as provided in the present invention.

FIG. 9 shows an internal structure diagram of a computer device as provided in the present invention.

### DETAILED DESCRIPTION OF THE EMBODIMENTS

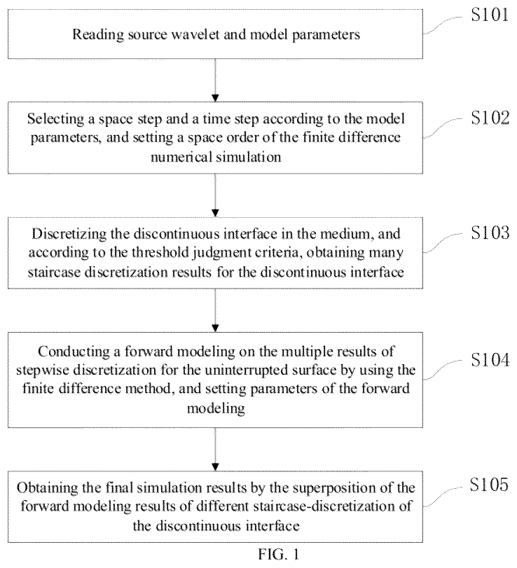

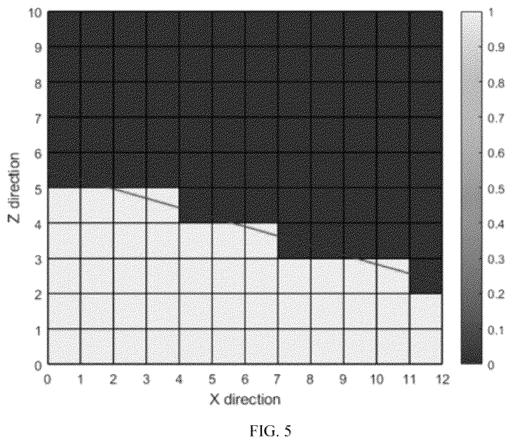

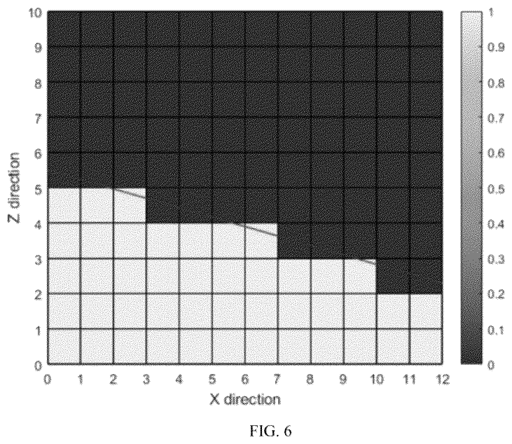

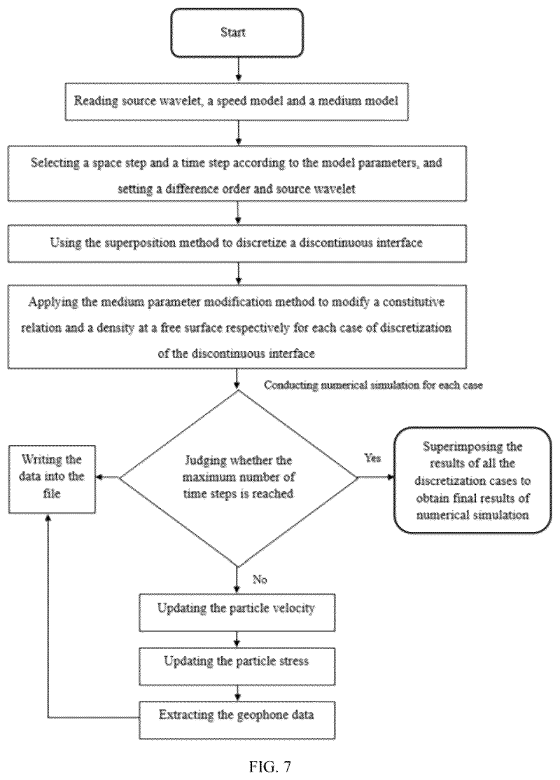

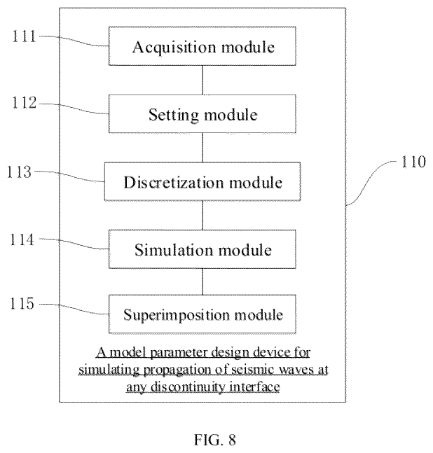

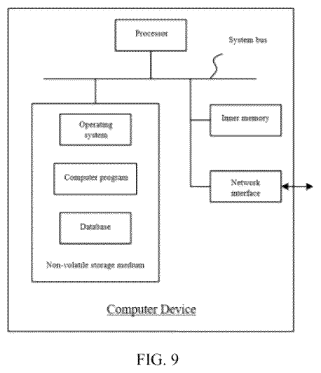

Referring to FIG. 1 to FIG. 9, the present invention provides a technical solution.

In seismology, we call a place where the seismic wave changes suddenly as a discontinuous surface. In terms of the physical properties of the physical medium (solid, liquid and gas) on both sides of the discontinuous surface, we can divide the discontinuous surfaces into the following four categories:
1) Solid/solid discontinuous surface.
2) Solid/liquid discontinuous surface,
3) Solid free surface (land surface)-solid/vacuum discontinuous surface,
4) Liquid free surface (sea level)-liquid/vacuum discontinuous surface.

The complicated wave conversion and the generation of interface wave with strong energy will occur in the vicinity of these physical discontinuous surfaces. For example, the solid/liquid discontinuous surfaces are often used to describe the sea floor interface or inner and outer core boundaries of the Earth in the vicinity of which a type of Scholtewave propagates along that interface and P-S wave conversion occurs. The solid free surface is used to describe the land surface which, acting as the discontinuous surface with the strongest impedance contrast of the Earth, generates strong-amplitude surface waves (Rayleigh wave or Love wave), with its dispersion characteristics having great significance and purpose in the near-surface seismic exploration. The liquid free surface is used to describe the ocean surface and is the cause of generation of multiple waves in the marine exploration; and it can be either considered as noise removed (multiple wave denoising technology) or used for illumination angle and area compensation (multiple wave imaging technology).

In the numerical simulation of seismic waves in the complicated medium, the combination of the above-mentioned discontinuous surfaces is often encountered, and the correct numerical modeling expression of such discontinuous surfaces will directly influence the accuracy and precision of the numerical simulation. Especially for the near-surface seismic data observed and the seismic data observed by the sea floor seismometer, its geophone and seismometer are directly located on or near the discontinuous surfaces, so they are more influenced by the discontinuous surfaces. Whether the numerical simulation for the wave field near the discontinuous surface can be performed correctly will directly influence the extraction and analysis of such seismic data.
1) The grid refinement and parameter smoothing are applied for the strong discontinuous interface of the medium thus to ease the parameter comparison between both sides of the interface, so as to ensure the stability and accuracy of the numerical simulation algorithm on the whole. It will increase the computation work and memory consumption, and reduce the accuracy of numerical simulation of wave propagation at the interface. Specifically, the smoothing methods of parameters related to reducing the accuracy of numerical simulation of wave propagation include parameter geometry, algebraic average, wave-number domain low-pass filtering and many other relevant researches.
2) Finite element methods include the spectral element method and the intermittent finite element method (Komatitsch and Tromp, 1999; Komatitsch et al., 1999; Tromp et al., 2008; Peter et al., 2011). For these types of numerical simulation methods based on the weak solution form of partial differential equation, reference can be made to the existing spectral element method open source package: SPECFEM2D and SPECFEM3D

Disadvantages: the original program framework of the finite difference method is no longer applicable, and it is necessary to redevelop all forward and inverse programs under the framework of the finite element method. Moreover, compared with finite difference method, the finite element method features more complicated algorithm theory and implementation, massive computation and high memory consumption.
3) Discretization methods based on Mimetic operators, e.g., de la Puente et al. (2014). Shragge and Tapley (2017), Konuk and Shragge (2020), Shragge and Konuk (2020), Sethi et al. (2021).

This is a method between the finite difference method and the finite element method. It applies a special operator derived from the finite element method at the strong discontinuous interface, while it uses the traditional finite difference operator in the area without a strong discontinuous interface. Similarly, there is also the Curvilinear finite difference method.

Disadvantages: the implementation of the algorithm is complicated, which requires the creation of extra memory space to store geometric topological variables; moreover, the computation stability will be also affected by the maximum curvature of the discontinuous interface. The larger the curvature is, the more unstable it is.

Method Invention:

Based on the averaging theory in the isotropic medium and the linear superposition principle in multi-dimensional space, medium parameter modeling methods are successively proposed for accurate and efficient simulation of seismic wave propagation at the following strong discontinuous interfaces:
1) Solid/liquid discontinuous surface: further extension is applicable to the solid part which consists of anisotropic medium.
2) Solid free surface (land surface)-solid/vacuum discontinuous surface: there are additional two cases for the further extension. It is applicable to the liquid free surface (sea level)-liquid/vacuum discontinuous surface when the shear modulus of the medium below the discontinuous surface is zero; and it is applicable to the solid part which consists of anisotropic medium.

The present invention has the following advantages.
1) It can be used as a discretization model generation and preparation program, and can be directly integrated and applied to the existing velocity-stress staggered grid finite difference numerical programs in both the industry and the academia.
2) It can be accurately fitted with the spatial position of the discontinuous interface, and there is no rounding approximation used in the traditional staircase approximation method; moreover, there is no need for grid refinement and parameter smoothing at the strong discontinuous interface of the medium.
3) It requires only one medium model generation (i.e., the method in the present invention) in the whole numerical simulation, featuring the advantages of efficient calculation and simple operation etc.
4) The medium models generated using this method are independent from each other, and their respective numerical simulations can be calculated in parallel (MPI or GPU); and finally, all wave fields are superimposed, greatly improving the computational efficiency.
5) The staircase approximation of the strong discontinuous interface of the medium can realize the numerical simulation of the undulating discontinuous surface without any stability problem due to the maximum curvature constraint.
6) The high-order finite difference operator can be used to achieve the calculation precision equivalent to that of the precise realization method based on the weak solution class of the partial differential equations.

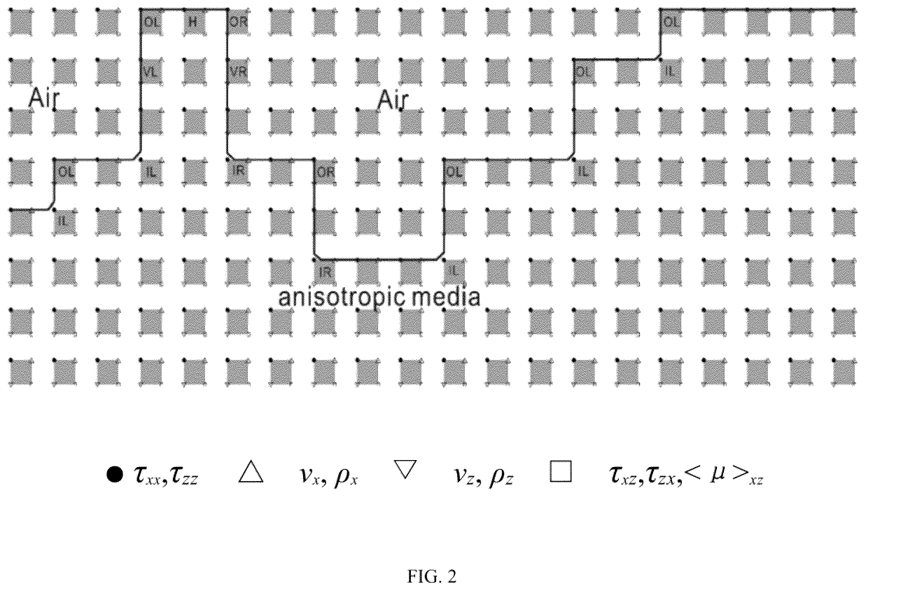

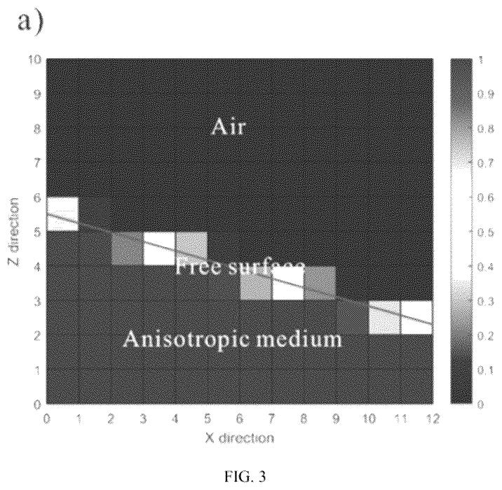

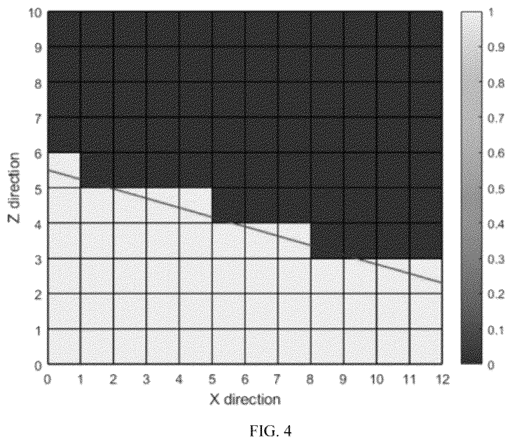

Taking the discontinuous surface in the anisotropic medium as an example, as shown in FIG. 2, the staircase approximation method is applied to represent the discontinuous interface in any form, and the medium parameter averaging method is used to conduct numerical simulation at the discontinuous interface. For the superposition method, its schematic diagram is as shown in FIG. 3. Each grid point in FIG. 3 represents a grid cell, and red lines (oblique lines between ordinates 5 and 6) represent discontinuous interfaces. For the purpose of the traditional staircase approximation, when the percentage of the grid area below the discontinuous interface to the entire grid area (this percentage is called the weighting coefficient α(x,z)) is greater than 0.5, the grid cells intersecting the red lines are designated as the medium type below the discontinuous interface. For the purpose of the superposition method, we carry out many times of discretization of the discontinuous interface through the parameter N. The staircase discretization method for each time is determined by a threshold value. When the weighting coefficient α(x,z) is greater than that threshold, the grid node in question is considered as the medium below the discontinuous interfaces, and the threshold is determined by Formula (1). Kₙ(x,z) represents the medium type of the grid node; Kₙ(x,z)=1 means that the medium at that grid node is the medium below the discontinuous interface; Kₙ(x,z)=0 means that the medium at that grid node is the medium above the discontinuous interface. Take FIG. 4 to FIG. 6 as examples, at this point, N is equal to 3. Therefore, we conduct three times of staircase discretization of discontinuous interface, respectively conduct numerical simulation on results of each discretization, and then superpose results by Formula (2) to obtain final results of numerical simulation. In Formula (1) and Formula (2), x and z mean grid coordinates, t represents time, and V represents a particle velocity.

$${κ}_{n} ( x , z ) = \{ \begin{matrix}1 & α ( x , z ) > \frac{n}{N + 1} \\ 0 & α ( x , z ) \leq \frac{n}{N + 1}\end{matrix} \qquad ( 1 )$$

$$v ( x , z , t ) = \frac{1}{N} {\sum }_{n = 1}^{N} v ( x , z , t , n ) \qquad ( 2 )$$

where, in FIG. 3 to FIG. 6: [symbol] represents stress components; Vx Vz represents velocity components; ρₓ,ρ_{z} represents density; μ [symbol] represents Lame constant; the anisotropic medium represents an anisotropic medium; Air represents an air medium; and Free surface represents a free surface.

Flow of the Algorithm:

First step: read the source wavelet and medium model (the medium model refers to reading of the medium velocity, density and other parameters, such as transverse wave velocity, longitudinal wave velocity, medium density and anisotropic parameters).

Second step: select the appropriate space step and time step according to the model parameters (such as the transverse wave velocity and source wavelet frequency) of the model, and set the space order of the finite difference numerical simulation.

Third step: discretize the discontinuous interface in the medium in the principle of superposition method by using the model parameter design method, and obtain multiple results of staircase discretization for the discontinuous interface according to the threshold judgment criteria given in the Formula (1).

Fourth step: use the finite difference method to conduct a forward modeling on the multiple results of staircase discretization for the discontinuous interface obtained in each step mentioned above, and set parameters of the forward modeling (such as simulation time, location of geophone and location of source).

Fifth step: superimpose the results of all the forward modeling to obtain final results of forward modeling.

In the present invention, the computer device may include a memory, a storage controller, one or more (only one is shown in the figure) processors and the like. Various components are electrically connected in a direct or indirect manner to realize data transmission or interaction. For example, these components may be electrically connected via one or more communication buses or signal buses. The model parameter design method for simulating propagation of seismic waves at any discontinuous interface includes at least one software function module that can be stored in memory in the form of software or firmware, such as, the software function module or computer program included in the instrument used for simulating propagation of seismic waves at any discontinuous interface. The memory can store various software programs and modules, such as the program instructions/modules corresponding to the model parameter design method and device for simulating the propagation of seismic waves at any discontinuous interface as provided in the embodiment of this application. By running the software programs and modules stored in the memory, the processor performs various functional applications and data processing to realize the analytical method in the embodiment of this application.

Although embodiments of the present invention have been indicated and described, it should be understood that for ordinary technicians in this field that these embodiments can be changed, modified, replaced and varied in a variety of forms without deviating from the principle and spirit of the present invention. The scope of the present invention is limited by the attached claims and their equivalents.

What is claimed is:

1. A model parameter design method for simulating propagation of seismic waves at any discontinuous interface, comprising:
reading source wavelet and model parameters;
selecting a space step and a time step according to the model parameters, and setting a space order of the finite difference numerical simulation;
discretizing the discontinuous interface in the medium, and according to the threshold judgment criteria, obtaining many staircase discretization results for the discontinuous interface;
conducting a forward modeling on the obtained multiple results of staircase discretization for the discontinuous interface by using the finite difference method, and setting parameters of the forward modeling; and
obtaining the final simulation results by the superposition of the forward modeling results of different staircase-discretization of the discontinuous interface.

2. The method according to claim 1, wherein the model parameters include source wavelet frequency, transverse wave velocity, longitudinal wave velocity, medium density and anisotropy parameters.

3. The method according to claim 1, wherein the principle of superposition method is applied to discretize the discontinuous interface in the medium.

4. The method according to claim 1, wherein the threshold judgment criteria is obtained by the following formula:
$${κ}_{n} ( x , z ) = \{ \begin{matrix}1 & α ( x , z ) > \frac{n}{N + 1} \\ 0 & α ( x , z ) \leq \frac{n}{N + 1}\end{matrix} ,$$
and the modeling results are obtained by the following formula:
$$v ( x , z , t ) = \frac{1}{N} {\sum }_{n = 1}^{N} v ( x , z , t , n ) ,$$
wherein Kₙ(x,z) represents the medium type of a grid node; Kₙ(x,z)=1 means that the medium at that grid node is a medium below the discontinuous interface: Kₙ(x,z)=0 means that the medium at that grid node is a medium above the discontinuous interface; α(x,z) represents a weighting coefficient; x and z mean grid coordinates; t represents time; v represents a particle velocity; n represents results of N^{th} staircase discretization; and N represents the number of times of staircase discretization.

5. The method according to claim 1, wherein for each case of discretization of the discontinuous interface, the medium parameter modification method is used to modify a constitutive relation and a density at a free surface respectively to conduct the numerical simulation for each case and to judge whether a maximum number of time steps is reached.

6. The method according to claim 5, wherein if the maximum number of time steps is reached, the results of all the discretization cases are superimposed to obtain the final results of the numerical simulation; and if the maximum number of time steps is not reached, the particle velocity and particle stress are updated, and then geophone data is extracted and written into a file to rejudge whether the maximum number of time steps is reached.

7. A model parameter design device for simulating propagation of seismic waves at any discontinuous interface, comprising:
an acquisition module used to read source wavelet and model parameters;
a setting module used to select a space step and a time step according to the model parameters and to set a space order of the finite difference numerical simulation;
a discretization module used to discretize a discontinuous interface in the medium and obtain multiple results of staircase discretization for the discontinuous interface according to the threshold judgment criteria;
a simulation module used to conduct a forward modeling on the obtained multiple results of staircase discretization for the discontinuous interface by using the finite difference method and to set parameters of the forward modeling;
a superimposition module used to superimpose the results of all the forward modeling to obtain final results of the forward modeling.

8. A computer device comprising a memory and a processor, wherein the memory stores computer programs executed by a processor to implement the procedures of the method of claim 1.
